(19) United States
(12) Patent Application Publication
(10) Pub. No.: US 2023/0111047 A1
(43) Pub. Date: Apr. 13, 2023

(54) Classification Evaluation and Improvement in Machine Learning Models

(71) Applicant: ServiceNow, Inc., Santa Clara, CA (US)

(72) Inventors: Lindsay Devon Brin, Ontario (CA); Joseph Béchard Marinier, Montreal (CA); Uyen Diana Vu Le, San Diego, CA (US); Christopher John Tyler, Montreal (CA); Parmida Atighehchian, Montreal (CA); Gabrielle Gauthier-Melançon, Montreal (CA); Frédéric Branchaud-Charron, Montreal (CA); Orlando Marquez Ayala, Montreal (CA)

(21) Appl. No.: 17/500,721

(22) Filed: Oct. 13, 2021

(51) Int. Cl. G06K 9/62; G06N 20/00

(52) U.S. Cl. CPC G06K 9/6265; G06K 9/6277; G06K 9/628; G06K 9/6215; G06K 9/6253; G06K 9/6256; G06N 20/00

(57) ABSTRACT

Persistent storage contains a training dataset and a test dataset, each with units of text labelled from a plurality of categories. A machine learning model has been trained with the training dataset to classify input units of text into the plurality of categories. One or more processors are configured to: read the training dataset or the test dataset; determine distributional properties of the training dataset or the test dataset; determine, using the machine learning model, saliency maps for tokens in the training dataset or the test dataset; perturb, by way of token insertion, token deletion, or token replacement, the training dataset or the test dataset into an expanded dataset; obtain, using the machine learning model, classifications into the plurality of categories for the expanded dataset; and based on the distributional properties, the saliency maps, and the classifications, identify causes of failure for the machine learning model.

### BACKGROUND

Machine learning models have proven to be beneficial for various types of data classification tasks, often able to equal or surpass human ability. These tasks may include classification of images, text, spoken language, binary data, genome samples, and so on. However, most models fail to perform sufficiently on at least some input data. When this happens, it can be exceptionally challenging to determine the cause or causes of the failure. Possible causes might include problems with training data used to train the model, problems with test data used to test the model, problems with the model itself, problems with how the model is being applied, and/or various combinations of these problems. For models that perform intent classification—seeking to determine the semantic intent of text or speech based on the language therein—determining reasons for model failure can be even more difficult.

### SUMMARY

The embodiments herein address these and possibly other technical problems by providing a suite of techniques that can be used to determine possible and/or likely root causes of machine learning model failure. Advantageously, suggested causes can be identified and then cross-referenced with one another by way of different techniques to improve the accuracy of the suggestions. Furthermore, some automated improvements to a model can be made, such as removing identified errors from training and/or test data and then retraining or retesting the model. Moreover, a set of graphical user interfaces can be used to display the results of each technique's analysis, allowing a user to identify specific problems. These embodiments focus on problems related to intent classification, but they can be applied more broadly.

Accordingly, a first example embodiment may involve persistent storage containing a training dataset and a test dataset, each with units of text that are labelled with one or more of a plurality of categories. The first example embodiment may also involve a machine learning model, trained with the training dataset to classify input units of text into the plurality of categories, and tested with the test dataset. The first example embodiment may also involve one or more processors configured to: read, from the persistent storage, the training dataset or the test dataset; determine, by way of statistical metrics, distributional properties of the training dataset or the test dataset; determine, by way of the machine learning model, saliency maps for tokens in the training dataset or the test dataset; perturb, by way of token insertion, token deletion, or token replacement, the training dataset or the test dataset into an expanded dataset; obtain, by way of the machine learning model, classifications into the plurality of categories for the expanded dataset; and based on the distributional properties, the saliency maps, and the classifications, identify one or more potential causes of failure for the machine learning model.

A second example embodiment may involve reading, from persistent storage, a training dataset or a test dataset, each with units of text that are labelled with one or more of a plurality of categories, wherein a machine learning model has been trained with the training dataset to classify input units of text into the plurality of categories, and has been tested with the test dataset. The second example embodiment may also involve determining, by way of statistical metrics, distributional properties of the training dataset or the test dataset. The second example embodiment may also involve determining, by way of the machine learning model, saliency maps for tokens in the training dataset or the test dataset. The second example embodiment may also involve perturbing, by way of token insertion, token deletion, or token replacement, the training dataset or the test dataset into an expanded dataset. The second example embodiment may also involve obtaining, by way of the machine learning model, classifications into the plurality of categories for the expanded dataset. The second example embodiment may also involve based on the distributional properties, the saliency maps, and the classifications, identifying one or more potential causes of failure for the machine learning model.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts machine model training, testing, and deployment to production use, in accordance with example embodiments.

FIG. 7 depicts a software framework, in accordance with example embodiments.

FIGS. 8, 9A, 9B, 9C, 10, 11, 12A, 12B, 12C, and 13 depicts various graphical user interfaces, in accordance with example embodiments.

FIG. 14 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

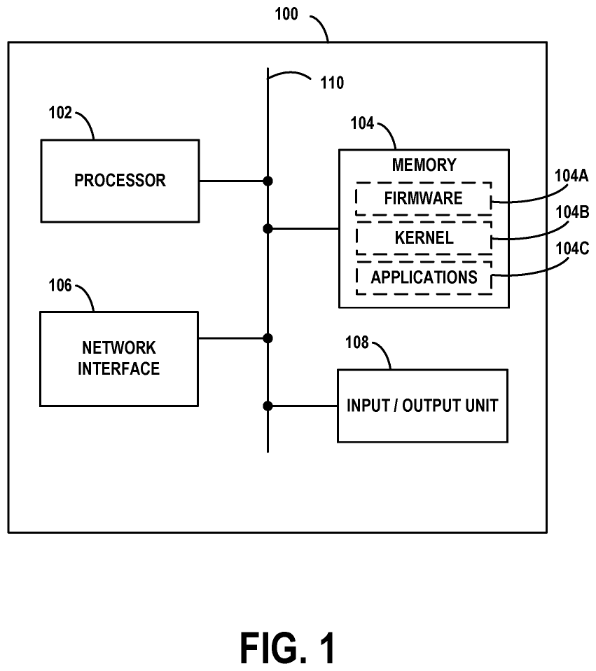

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

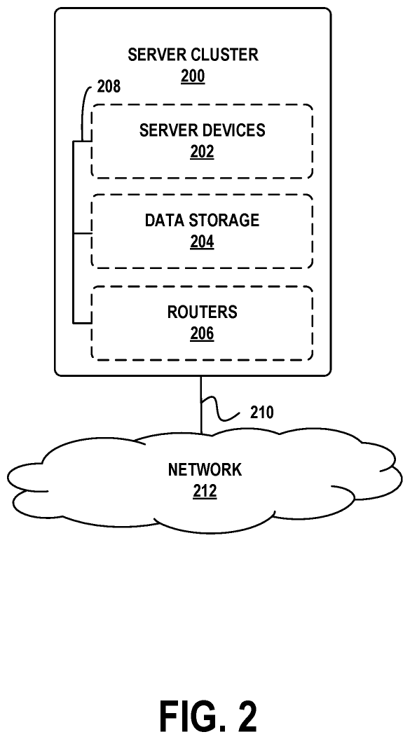

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

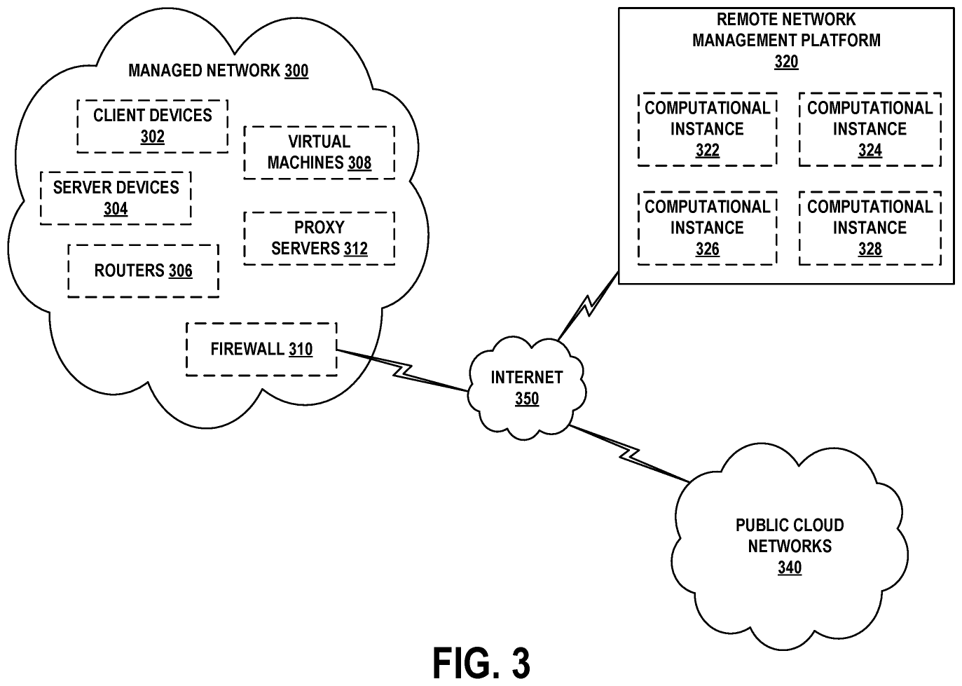

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

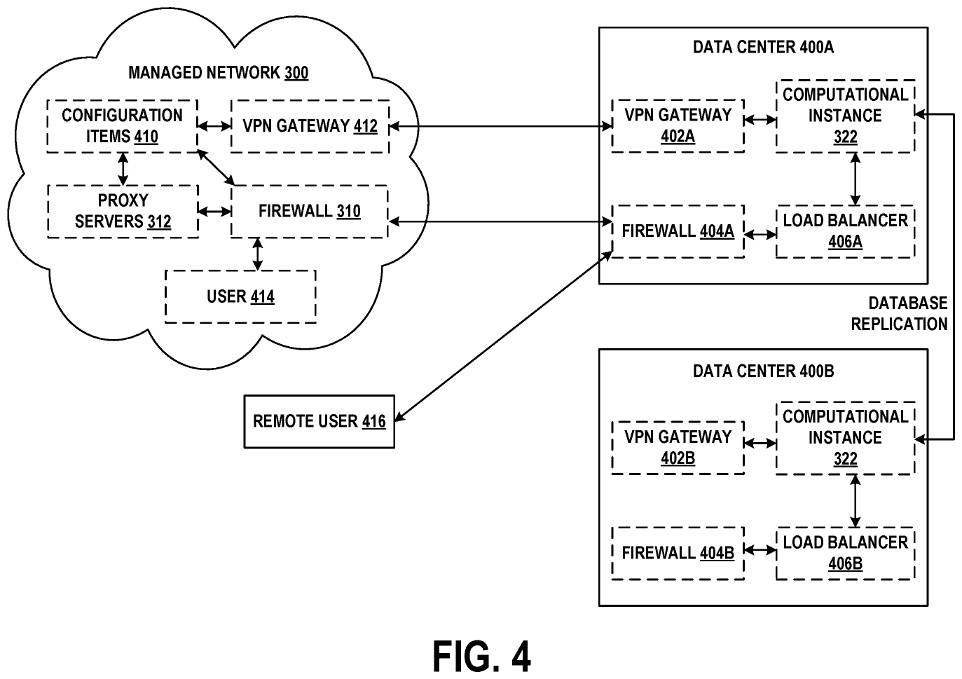

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

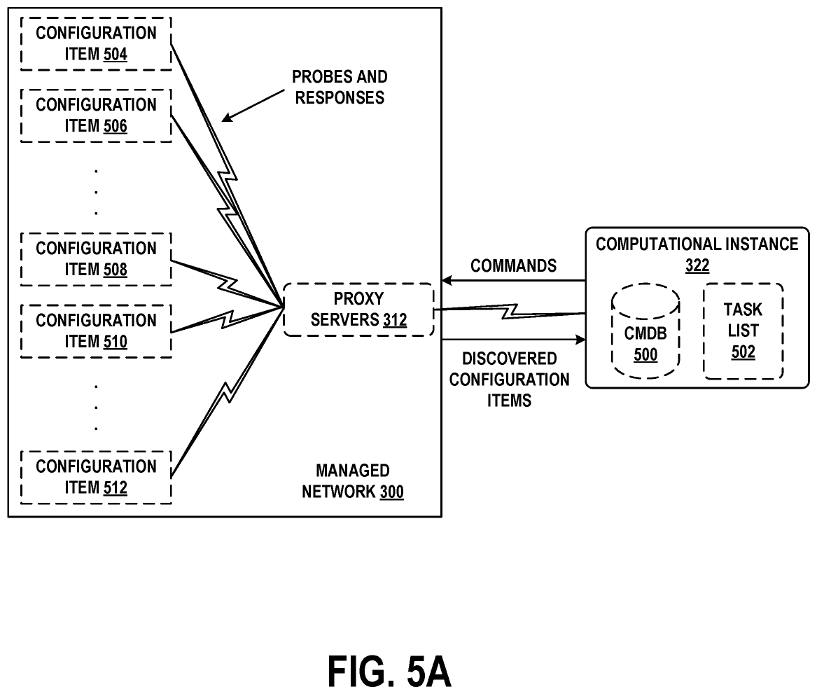

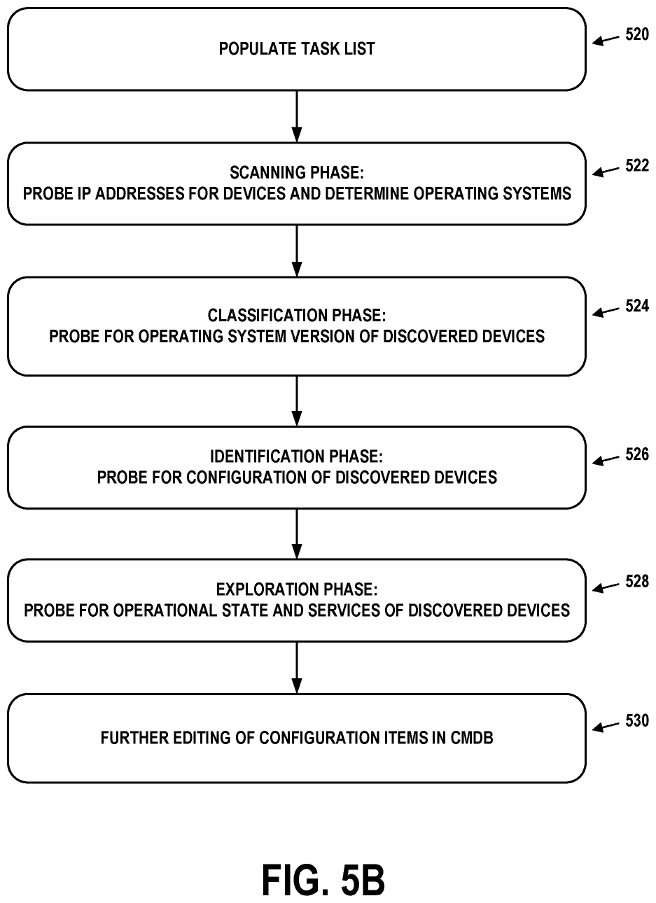

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Machine Learning Overview

Machine learning (ML) generally refers to a suite of artificial intelligence techniques that use data and algorithms to either mimic human learning or develop new approaches to learning that differ from human procedures. Indeed, many machine learning methods would be practically impossible for humans to carry out.

Unlike traditional software, which uses algorithms written to solve a particular problem or set of problems, machine learning involves training a model with a set of training data. The training data may be labeled (supervised learning), in that each unit of data is associated with a ground-truth output value that represents, for example, a classification, representation, or interpretation of the unit of data. In other cases, the training data is not labeled (unsupervised learning), and the model infers characteristics of the training data. When provided with enough training data and trained for a sufficient number of iterations, a model can be expected to perform certain tasks reasonably well.

The machine learning models described herein may include neural networks, decision trees, linear regression, logistic regression, support vector machines, naïve Bayesian networks, and so on. Various types of ensemble models may use two or more of these techniques in different configurations (e.g., in series or in parallel).

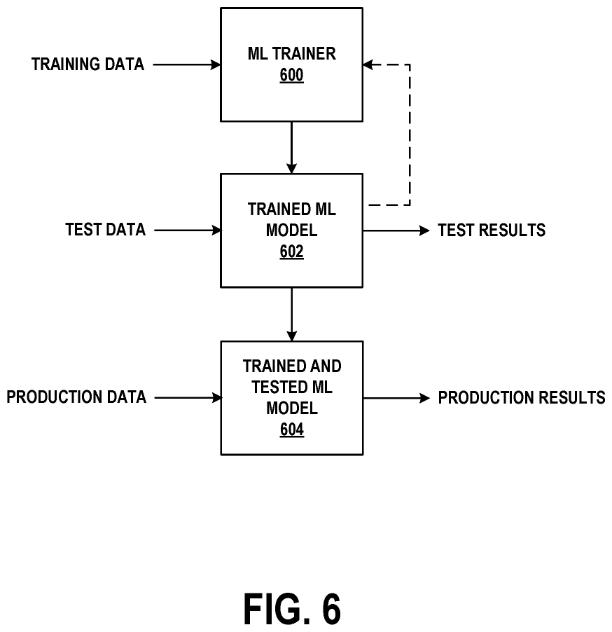

FIG. 6 depicts machine learning model training, testing, and deployment to production use. ML trainer 600 is an algorithm or suite of algorithms that takes training data as input and produces trained ML model 602 as output. Thus, ML trainer 600 may use any viable technique for training one or more of neural networks, decision trees, linear regression, logistic regression, support vector machines, naive Bayesian networks, etc. This training may involve the use of various hyperparameters, such as depth (tree depth or network depth), activation functions, loss functions, scaling factors, and so on.

Test data is then provided to trained ML model 602, and trained ML model 602 produces test results. The test data is typically a different dataset than the training data, but should have similar characteristics. The purpose of this testing to verify that trained ML model 602 has achieved some degree of generalization—that it can accurately produce output for input that is not part of its training data.

If the test results are sufficiently accurate (e.g., better than 80%, 90%, or 95% accuracy based on predetermined requirements), trained ML model 602 is promoted to production use as trained and tested ML model 604. If not, and as indicated by the dotted line from trained ML model 602 to ML trainer 600, the training process may continue with different training data and/or different hyperparameters until model accuracy requirements are satisfied.

Trained and tested ML model 604 may receive production data from a real-world application or scenario and produce production results. Ideally, trained and tested ML model 604 is robust enough to be able to provide production results with a sufficient level of accuracy, perhaps matching the accuracy determined by testing.

In some cases, trained ML model 602 and/or trained and tested ML model 604 also produce confidence values for each classified unit of data (e.g., in a range of 0% to 100%). For example, the distribution of the overall classification accuracy may be assumed to be Gaussian or binomial, and confidence intervals can be calculated based on this assumption using basic statistics. The smaller the confidence interval, the more confident the model (e.g., a confidence interval of 0 indicates 100% confidence).

Classification has proven to be one of the most useful applications of machine learning. As an example, it is now routine for certain types of image classification machine learning models to outperform most humans. Classification may be considered to be a form of prediction, and therefore accuracy is important if not critical in many tasks.

As general procedure, various types of machine learning models might take textual, audio, video, image or binary data as input and attempt to classify each discrete unit of this input into one (or more) of a number of categories. A binary classifier, for instance, can be used to detect whether incoming email is spam or is not spam. Classifiers that are more complicated might attempt to identify the objects in an image (e.g., animals, people, buildings, terrain) or types of errors in software program output.

A particularly challenging type of classification is commonly used for natural language processing (NLP) and natural language understanding (NLU). The goal of this form of classification is to determine the intent of a unit of text. This unit of text may include one or more tokens, along with whitespace, punctuation symbols, and/or other characters. Thus, it may take the form of a sentence or paragraph, but it could also be unstructured. In some cases, the text is in one language but multiple languages might be present. In some cases, the text may be a transcription of audio input from a human user (e.g., an utterance).

Note that herein the terms “token” and “word” may be used somewhat interchangeably, in that words are often referred to as “tokens”. Nonetheless, in some models, one word can include multiple tokens.

Referring back to FIG. 6, the training data could be a set of English sentences, each with labeled with a ground truth intent. For instance, the sentence “Please let me see my account balance” might be labeled with the intent “balance”, while the sentence “I want to pay my most recent bill” might be labeled with the intent “bill pay”. ML trainer 600 may use this training data to create mappings or representations of the input sentences. For example, word vector, paragraph vector, and/or transformer-based language model (such as bidirectional encoder representations from transformers (BERT)) techniques can be used to create multi-dimensional representations of input text. These representations may encode a predicted semantic meaning, or intent, of the associated input texts. Where the differences between these multi-dimensional representations are within certain bounds (e.g., clusters), the associated input texts may be considered to have the same or a similar intent.

Trained ML model 602 may be tested with additional sentences, also labeled with ground truth intents. For example, a test case may be whether trained ML model 602 correctly predicts the intent of the sentence “What is the total of my account?” as “balance”, even though this sentence did not appear in the training data and does not include the token “balance”.

Some of the reasons that intent classification is difficult is that it may require some form of contextual or fuzzy reasoning, and that the number of categories into which the units of text are classified can be quite large and could possibly overlap in unexpected ways. Further, some natural language phrases have no specific intent when viewed in isolation, such as “Hi, my name is Alice”, or have no specific intent due to being incomplete or ambiguous, such as “Can you please get me that?”

Intent classification underlies many of today's NLP/NLU tasks, such as database and web searching, as well as chat bot, smart speaker, and digital personal assistant operation. For example, a user might ask a smart speaker “What is today's forecast for Chicago?” The smart speaker may transmit this audio input (or a representation thereof) to a remote server. The remote server may use a machine learning model to transform the audio or representation into an intermediate format (e.g., a vector in n-space) and then compare this vector to a plurality of predetermined vectors with known intent in order to identify similar vectors. From this analysis, the intent of the user's question might be inferred, and the remote server may supply a response to the smart speaker for playout to the user.

In order for the classification task to be successful for this example, the model would have to determine that the user is a requesting (i) a weather report, (ii) for today, (iii) in the vicinity of Chicago. If the model fails to identify these three aspects of the user's intent, the model is unlikely to provide the desired result.

Such a machine learning model could produce incorrect or unexpected results for a number of reasons. These reasons include, but are not limited to, limitations of training data used to train the model, limitations of test data used to test the model, limitations of the model itself, and/or limitations of how well the model can be applied to this classification task.

Training data limitations occur when the model is not trained with enough data representing the general classification tasks for which it is to be used. For example, if the model above is not trained with the word “Chicago”, it might not be able to reliably identify that word in user input and therefore be unable to provide weather reports for Chicago.

Test data limitations occur when the model is not tested with enough data representing the classification tasks for which it is to be used. For example, if the model above is not tested with the token “Chicago”, its ability to reliably identify that token in user input remains unverified and could be limited when put into production, despite training.

Another issue that can arise during both training and testing is mislabeled data. In other words, the training or test inputs are labeled with incorrect ground truth categories, which can cause the model to produce erroneous classifications.

Limitations of a model itself might be such that a model cannot accurately perform intent classification with at least some input no matter how well it is trained and tested. For instance, a model with a structure that is too simple in comparison to the complexity of its input data (e.g., too few layers or not enough depth) may be fundamentally unable to distinguish between certain categories of intent. Further, a model may have been trained using certain activation functions, loss functions, or other hyperparameters that have caused the model to perform poorly regardless of the quality of its training and testing.

Limitations of model application may exist where a certain type of model, that is well-suited for some classification tasks, is unsuccessfully adapted for a different set of classification tasks. The model itself might be sound, but it is being used in a problem domain for which it is has not been designed.

Of course, models can fail for multiple reasons, and there may be some extent of overlap between the reasons given above. Some industry studies suggest that between 50% and 85% of all machine learning models fail for various reasons, dramatically limiting their usefulness. Thus, it is desirable to reduce the likelihood of such failures when possible.

### VI. Identifying Causes of Model Failure

As noted, machine learning models can fail for numerous reasons, and it may be very complicated—if at all possible—to determine these reasons. Currently, there is a severe lack of techniques that can be used to diagnose problems with machine learning models in an efficient fashion. The embodiments herein propose using a combination of one or more diagnosis techniques (with improvements) in order to obtain a more comprehensive view of possible causes of model failure. Advantageously, these embodiments provide an objective and reproducible evaluation of model failure, which was not possible in the past.

As a preliminary discussion, some diagnosis techniques are described below. Nevertheless, other techniques can be used with these embodiments. Employment of these techniques may involve use of one or more model evaluation software tools that make use of the training data, test data, model, and/or the model's output to identify potential failure causes.

### A. Dataset Testing

Dataset testing involves examining training and/or test data to determine how well these datasets agree with one another. Some tests on these datasets may determine distributional skew across categories.

For instance, if the training data has an approximately uniform distribution of units of text per category while some categories are poorly represented in the test data, the datasets have may be divergent with respect to one another and a warning may be raised. For example, if any category of the two datasets differs in frequency or proportion by more than a predetermined amount (e.g., 5%), the distributions may be flagged as divergent. Alternatively or additionally, any category with less than a threshold number of entries may result in the datasets being flagged.

Additional tests may determine differences in syntactical aspects of the datasets. As an example, the number of tokens per unit of text may be counted. If the mean and/or the standard deviation of this count for the datasets varies by more than about 3 (e.g., the mean tokens per unit of training data text is 9, but the mean tokens per unit of test data text is 5), a warning may be raised.

Further tests may determine a difference in vocabulary between the datasets per category. If a particular set of tokens was used to train for classification in a particular category but a different set of tokens (e.g., partially overlapping or non-overlapping) was used to test for that category, a warning may be raised. For example, if a certain token is present more than a threshold number of times in a particular category of the test data but is absent from the training data (or vice versa), this could indicate that the training and test data used different vocabularies.

Other types of dataset testing may be used.

### B. Saliency Maps

The saliency of a token in a unit of text is an approximate measure of how important that token is to the resulting classification of the unit of text. For instance, tokens representing stop words (e.g., non-substantive prepositions and conjunctions) such as “it” and “the” are expected to have low saliency in most uses, whereas the token “laptop” is expected to have high saliency if the task is to classify IT-related problems experienced by users.

To estimate the saliency of each token in a unit of text to a particular category, the gradient of the loss function for this category is determined with respect to each n-dimensional embedding. Mathematically, this gradient can be calculated based on how the loss function changes with respect to changes in the embedding. The calculation could be, for example, a sum of the changes across the n dimensions or an average of these changes.

Since the category is determined from the embedding of the unit of text, the gradient can be used to indicate approximately how much the predicted category changes based on changes to the token. The higher this value, the more the token contributes to classification of the unit of text into the category. The same token could have different saliency values when used in different sentences.

The saliency of each token can be provided, listed, or ranked in some fashion. From these values, a user can determine whether the model is giving an appropriate level of importance (or lack of importance) to tokens for units of text in the training or test data. Notably, saliency maps are just one type of local explainability technique, and other types of these techniques can be used.

### C. Test Case Perturbation

Test case perturbation refers to modifying units of text in the training or test data by adding, removing, or replacing tokens or punctuation. Then the model is used to classify the modified units of text to determine whether the predicted category changes. For instance, the addition or removal of stop words (or other tokens that are otherwise expected to be neutral with respect to the category) and punctuation is not typically expected to change the result of the classification. Further, the replacement of one or more tokens with synonymous tokens is also not expected to change the result of the classification.

Synonymous tokens may include tokens with the same general meaning, or expansions (“I'd” to “I would”) or contractions (“I would” to “I'd”) of tokens. On the other hand, adding or removing a token that is not a stop word, or replacing a token with a non-synonymous token may be expected to have a greater impact on the resulting category. Other perturbations may include inserting typographical errors into tokens. For instance, the token “calendar” is often misspelled as “calender”.

Each type of perturbation may be generated from one or more lists or dictionaries of perturbations or perturbation rules. These might include a list of expansions, a list of contractions, a dictionary of synonyms, and/or a dictionary of misspellings.

Test case perturbation helps identify gaps in training and/or test data that may be the cause of model failure. For example, consider the unit of text “I'd like to order a new computer.” Perturbations of this sentence may include: “I would like to order a new computer”, “I' d like to purchase a new computer”, “I'd like to order a new PC”, and “I' d like to order a new computer, please.” Each of these perturbations does not change the overall semantic meaning of the sentence, as the user's intent is to obtain a new computer.

Thus, the model should classify each of these units of text into the same category. If the model does not do so, it may indicate that the model was not trained with enough of these variations. For example, if the model correctly categorizes “I'd like to order a new computer” but fails to identify an intent for “I would like to order a new computer”, this suggests that the model needs to be trained and/or tested with more expansions. Likewise, if the model correctly categorizes “I'd like to order a new computer” but fails to identify an intent for “I'd like to order a new PC”, this suggests that the model needs to be trained and/or tested with more synonyms for the term “computer”.

### D. Similarity

The similarities between units of text can be calculated based on their embeddings. For instance, an embedding in n-space may be calculated for each sentence of training and/or test data using paragraph vectors or transformer-derived sentence embedders. Then, for each embedding, a dot product (e.g., a similarity measure in n-space that may be equivalent to cosine similarity when vectors are normalized) can be calculated with some or all other embeddings. These dot products may be represented as a similarity score that takes on values between −1 and 1, for example, where values close to 1 indicate that their units of text are nearly semantically identical, values close to 0 indicate minimal similarity, and values close to −1 indicate that their units of text are semantically unrelated.

For each unit of text, a list of the other units of text that are most similar may be provided. This list can be the m most similar units of text (e.g., where m is 10, 20, 50, or 100). Alternatively, the list can be all units of text for which the similarity score is above a threshold value (e.g., 0.6, 0.7, 0.8), or based on the m most similar results above a similarity threshold.

The goal of this list is to help the user find similar examples, and assess whether these similar examples have been classified into the same or different categories. When similar units of text are from different categories, it might indicate a mislabeling issue, overlapping categories, or simply that the category of the unit of text is difficult to predict. As such, when a unit of text has a heterogeneous neighborhood in n-space—for example, more than a threshold percent (e.g., 70%, 80%, 90%) of its most similar units of text belonging to different categories, the unit of text may be flagged as having few similar neighbors.

A second goal of this list is to help the user determine whether there exist many training dataset examples that are similar to the unit of text. When the training dataset has few examples that are similar to a unit of text, the user may want to augment the dataset with more similar examples, which may improve the trained model.

### E. Cross-Validating Causes of Model Failure

The four diagnostic techniques for model failure presented above (dataset testing, saliency maps, test case perturbation, and similarity) may be used in isolation or may be combined with one another in various ways. For example, the perturbation of tokens with high saliency is expected to have more of an impact on classification than perturbation of tokens with low saliency. Thus, it may be helpful to identify synonyms of highly salient tokens, and test how the model performs with these synonyms replacing their highly salient counterparts. Also, if perturbing tokens with low saliency results in a change of classification, this may indicate that the training and/or test datasets do not have enough of these perturbations for the model to be robust.

Further, suppose that a saliency map indicates that a particular token has a high saliency. The test cases perturbing that token may be reviewed to determine whether the model is failing to recognize a synonym for the token.

Thus, the results or intuition provided by one of these techniques can be validated by one or more of the other techniques. Doing so provides the user with more confidence in whether they have identified a root cause of model failure.

### VII. Addressing Model Failure

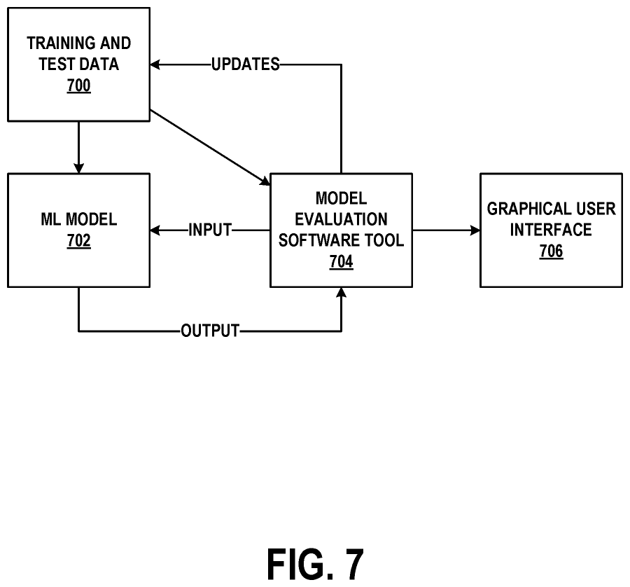

Model failure can be addressed in a number of ways. FIG. 7 provides a software framework through which a model evaluation software tool can carry out any of the techniques to identify model failure described above, and present this information in a useful fashion.

In FIG. 7, training and test data 700 has been used to train and test ML model 702 (which may be trained and tested ML model 604). Here, the training and testing processes are not explicitly shown for purposes of simplicity.

Model evaluation software tool 704 may be one or more software applications configured to perform any of the above or any other evaluations in order to identify possible causes of failure for ML model 702. Thus, model evaluation software tool 704 may obtain and process training and test data 700 (e.g., to carry out dataset testing or test case perturbation).

Model evaluation software tool 704 may also provide inputs to ML model 702 and receive corresponding outputs. For instance, the inputs provided by model evaluation software tool 704 may be used for generating saliency maps or determining similarities between units of text. In some cases, model evaluation software tool 704 may provide updates to training and testing data 700 (e.g., units of text to augment training and test data 700 and/or perturbed units of text generated from training and test data 700). These updates can be used to retrain ML model 702 (not shown, but discussed below).

Further, model evaluation software tool 704 may provide results of its evaluation on graphical user interface 706. Such a graphical user interface, examples of which are provided below, may provide one or more dashboards through which a user can easily determine the results of the evaluation as well as drill down for more detail regarding the evaluation and any associated recommendations.

### A. Retraining Models

Once possible causes of model failure have been identified, the model can be retrained with enhanced training data in an attempt to improve the model. For example, if dataset testing indicates that the model has not been sufficient trained with input that maps to one or more categories, additional input for these categories can be added to the training data.

Likewise, saliency maps could provide unexpected results. For instance, if stop tokens have a higher than expected saliency, or other tokens that are anticipated to have an important semantic influence over the classification process have a lower than expected saliency, units of text with more tokens of these types may be added to the training data.

Further, test case perturbation can be used to expand the amount of training data to include various types of additions of tokens, removals of tokens, replacement of tokens with synonyms of those tokens, and/or replacements of tokens with misspellings of those tokens. This can have a multiplicative impact on the size of the training dataset, as each unit of text therein could be used to generate several variations thereof. But doing so could dramatically increase training coverage.

Any such retraining could be triggered by a human or might occur automatically. For instance, a user may be presented, on a graphical user interface, with information related to possible causes of model failure. The user could be prompted to select one or more ways of modifying the training dataset and then cause retraining of the model. On the other hand, a tool that is configured to identify causes of model failure may identify one or more such causes, and then automatically initiate retraining of the model with a modified training dataset. Test datasets may also be modified in accordance with identified causes of model failure.

### B. Smart Tags

Smart tags are textual or graphical representations that describe various types of observations made by model evaluation software tool 704. They can be computed automatically, associated with tokens, units of text, or model output, and stored for later retrieval. Smart tags make it easier for a user to rapidly determine unusual characteristics of units of text in training and testing datasets and/or a model. Examples of smart tags follow, but different and additional smart tags may be possible. These examples assume that the units of text are generally in the form of sentences, but other textual structures may be supported as well.

multiple sentences: The number of sentences in a unit of text is above 1. All other smart tags may be disabled when this is the case.

long_sentence: The number of tokens is above 15.

short_sentence: The number of tokens is below or equal to 3.

missing_subj: The sentence is missing a subject.

missing_verb: The sentence is missing a verb.

missing_obj: The sentence is missing an object.

few_similar_neighbors: The sentence has very few similar sentences from the same category, as determined by the embeddings in n-space.

failed_typo: At least one typo test failed.

failed_neutraltoken: At least one neutral token test (e.g., adding neutral tokens such as “please” or “hello” to the unit of text) failed.

failed_punctuation: At least one punctuation test (e.g., removing or adding punctuation from or to a unit of text) failed.

Model performance per smart tag can also be determined. This provides indications of which types of errors are contributing the most to overall model error rates. In general, it may be likely that the more smart tags associated with a unit of text, the more likely that the model is going to fail for the unit of text or a similar unit of text. In this manner, problematic units of text can be identified.

### VIII. Example Graphical User Interfaces

As noted, model evaluation software tool 704 may generate graphical user interface 706 (which represents one or more graphical user interfaces). The following provides examples of such graphical user interfaces, and how they can be used to focus on determining possible causes of model failure as well as way of improving model efficacy. Nonetheless, other examples of graphical user interfaces may be used.

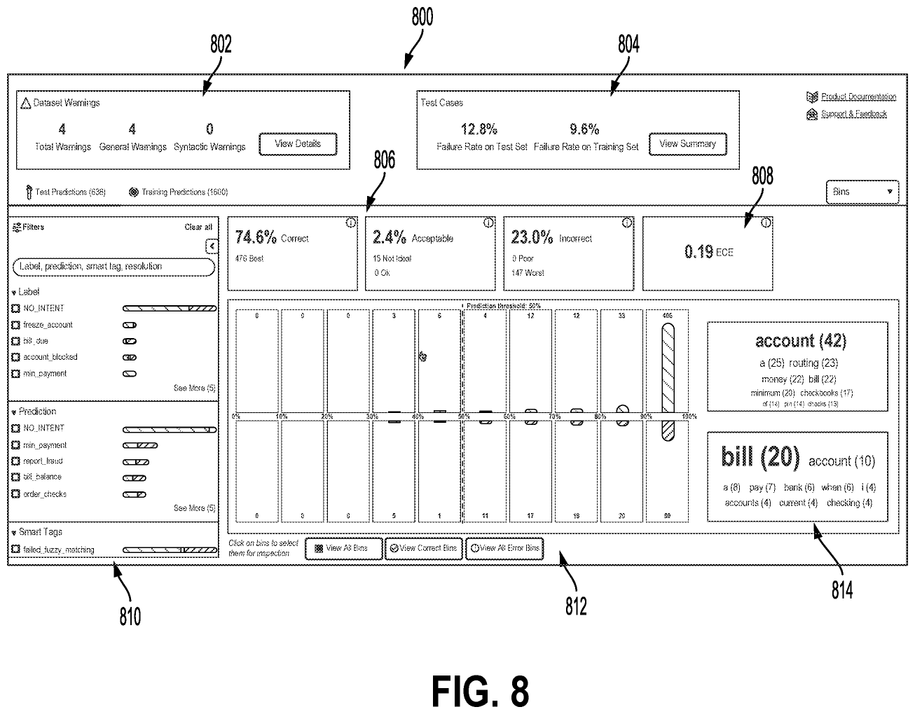

FIG. 8 depicts dashboard 800 with a number of sections. In alternative embodiments, more, fewer, or different sections may be present or these sections may be arranged differently. In FIG. 8, the sections include dataset warnings 802, test case warnings 804, test results 806, expected calibration error (ECE) 808, filter 810, histogram 812, and word cloud 814. Each of these sections may be actuatable to allow navigation to further graphical user interfaces, and are described by example below.

### A. Dataset Warnings

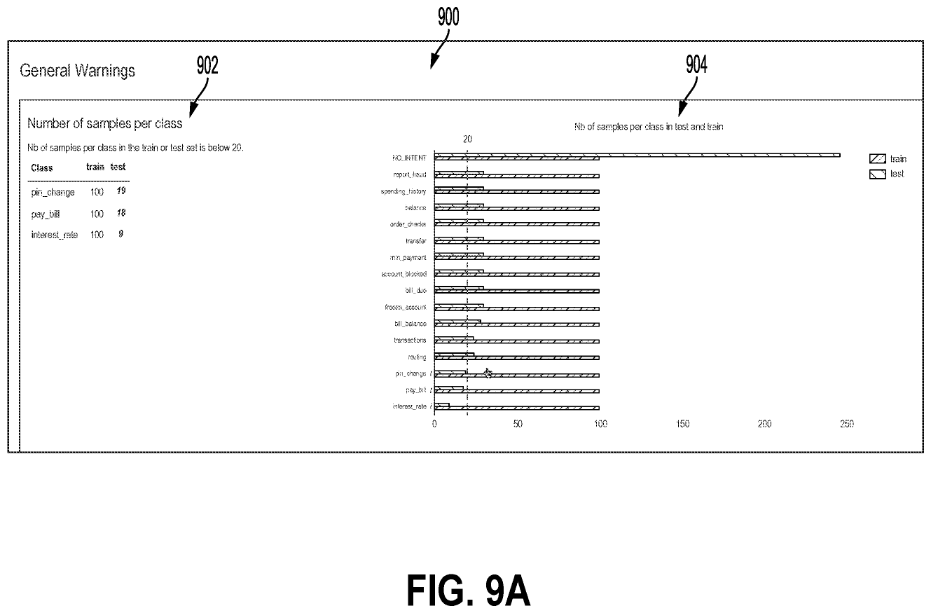

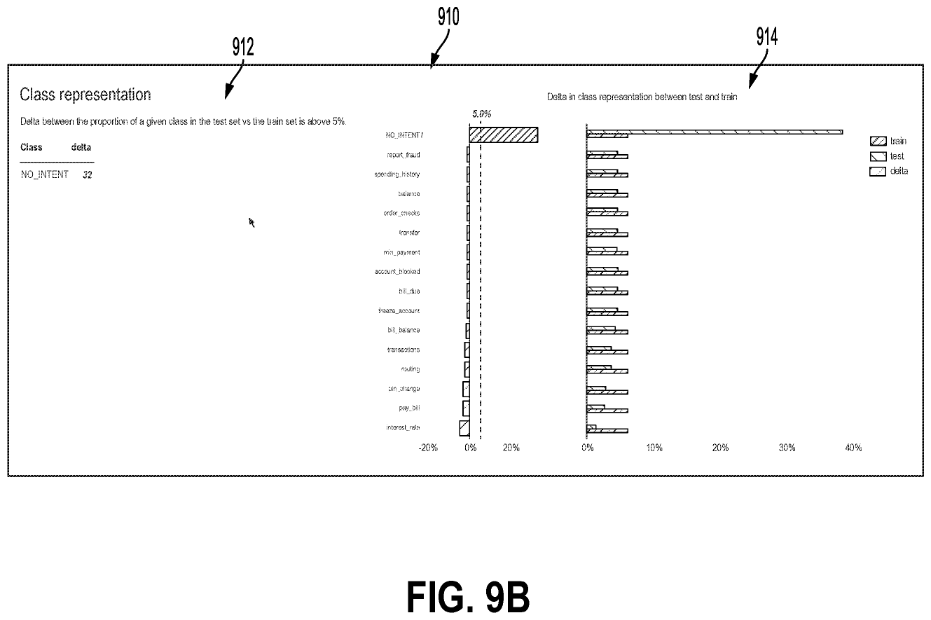

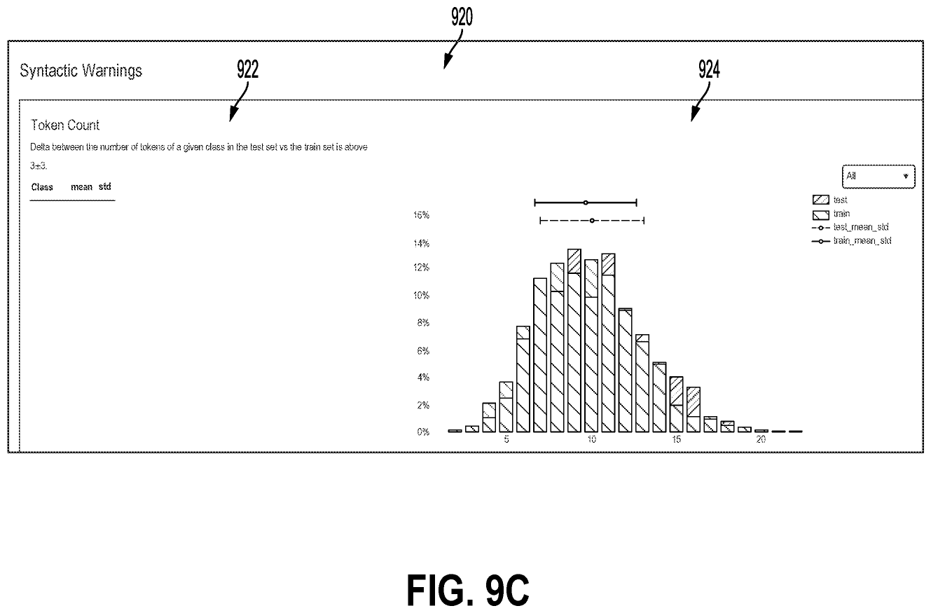

Dataset warning section 802 of dashboard 800 displays counts of total warnings, general warnings, and syntactic warnings related to the training and test datasets. Actuation of dataset warnings section 802 (e.g., the “view details” box) may result in the display of one or more of graphical user interfaces 900, 910, and/or 920 (shown in FIGS. 9A, 9B, and 9C, respectively). In various embodiments, the content of graphical user interfaces 900, 910, and/or 920 could be displayed together on the same graphical user interface.

Graphical user interface 900 of FIG. 9A displays general dataset warnings. Section 902 identifies a list of categories (classes) for which the number of samples in either the training or test data is below 20. In some embodiments, a threshold other than 20 may be used. Section 904 includes a bar chart of samples per test class in the training and test datasets, respectively. These sections allow rapid visual identification of dataset divergence. For example, section 904 clearly indicates that there is a disproportionately large number of units of text in the test dataset that are labeled as having no intent.

Graphical user interface 910 of FIG. 9B displays category (class) representation warnings. Section 912 identifies a list of categories (classes) for which the difference between proportional membership of the training and test datasets is greater than 5%. In some embodiments, a threshold other than 5% may be used. Section 914 includes a bar chart of category (class) representation for the training and test datasets, respectively. These sections also allow rapid visual identification of dataset divergence. For example, section 914 also indicates that there is a disproportionately large number of units of text in the test dataset that are labeled as having no intent.

Graphical user interface 920 of FIG. 9C displays category syntactic warnings. Section 922 identifies a list of categories (classes) for which the difference between the token count mean or token count standard deviation of the training and test datasets is greater than 3. In some embodiments, a threshold other than 3 may be used. Section 922 is empty because there are no categories that meet this threshold. Section 924 provides overlapping histograms of the number of units of text (utterances) with various token counts for the training and test data. As an example, section 924 indicates that the distributions of token counts are quite similar for the training and test data.

### B. Perturbation Test Case Results

Turning back to FIG. 8, test case results section 804 of dashboard 800 displays failure percentages relating to test case perturbation of the training and test datasets. Actuation of test case results section 804 (e.g., the “view summary” box) may result in the display of one or more of graphical user interfaces relating to failure rates of various types of perturbations.

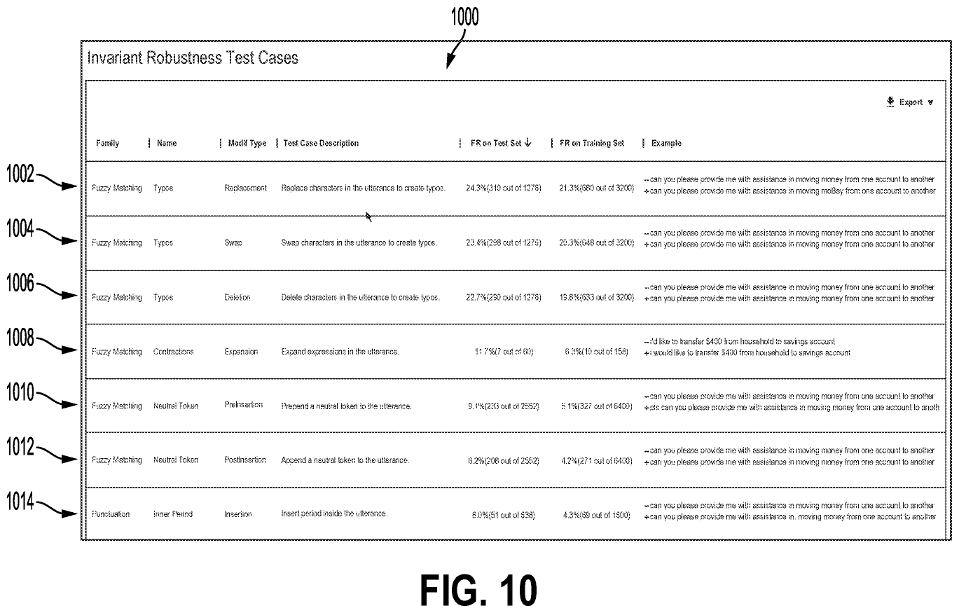

As an example, graphical user interface 1000 of FIG. 10 provides an overview of invariant robustness test cases. Seven types of test case perturbations are shown, with failure rates and examples of each. Perturbations 1002, 1004, and 1006 introduce various typographical errors into units of text, and the associated test cases have failure rates of between 22.7% and 24.3% on the test dataset and only slightly lower failure rates on the training dataset. This suggests that the model can be confused by typographical errors and should be trained to overcome this limitation.

Perturbation 1008 expands contractions in the datasets, while perturbations 1010 and 1012 add neutral tokens (e.g., “please”, “thank you”) to the datasets, and perturbation 1014 adds mid-sentence periods to the datasets. These perturbations result in lower failure rates than those introducing typographical errors, but still show room for improvement.

### C. Test Results

Turning back to FIG. 8, test results section 806 of dashboard 800 displays the overall results of applying the model to the test dataset. Particularly, test results section 806 shows that the model correctly classified 74.6% of the units of text in the test dataset, incorrectly classified 23.0% of these units of text, and classified 2.4% in an incorrect but acceptable fashion.

Acceptable misclassifications occur when the model does not produce the same classification as the ground truth label of a unit of text, but the discrepancy is not significantly impactful on users. For example, there may be two categories that are similar or overlap such that misclassifications into one when the other was the target are acceptable. Further, the user may be able to manually tag a specific misclassification as acceptable, which would result in additional misclassifications that are similar to also be considered acceptable.

### D. Histograms and ECE

ECE section 808 and histogram section 812 will be discussed together. Histogram section 812 represents the correctness of the model's predictions for the test dataset compared to the model's confidence in these predictions, and ECE section 808 is an efficient visual representation of the differences between model confidence and correctness.

Histogram section 812 includes 10 bins, one for each decile between 0% and 100%, inclusive. In some embodiments, there may be more or fewer than 10 bins. Each bin represents, with a bar extending up, the number of units of text from the test dataset with a confidence in that bin that were correctly classified. Each bin also represents, with a bar extending down, the number of units of text from the test dataset with a confidence in that bin that were incorrectly classified. For example, in FIG. 8, the 90%-100% bin contains 406 correct predictions and 89 incorrect predictions. In some embodiments, the bars may extend in different directions, and bars may be included that indicate the number of units of text from the test dataset that were acceptably misclassified.

Thus, histogram section 812 depicts the difference between expected model accuracy (confidence) and actual model accuracy (correct and incorrect predictions per bin). In the example shown, there are 495 classifications in the 90%-100% bin, but only 82% of them were correct. This implies that the model is overconfident in its predictions, and/or poorly calibrated, which is common for neural networks. In some cases, this may indicate an overlap between two or more categories.

Another way of representing the difference between expected model accuracy and actual model accuracy is compactly shown in ECE section 808. An ECE value is calculated as follows. First, the absolute value of the difference between model accuracy and model confidence is determined for each bin. The accuracy and confidence values are averages per bin. Then, the ECE is determined as the weighted average of these differences over all bins, where weights are based on the number of examples per bin. The higher the ECE, the less agreement there is between model accuracy and model confidence. Thus, when ECE exceeds a threshold value (e.g., 0.2, 0.3, 0.4), it indicates that the model is poorly calibrated (its confidence values are inaccurate), and that that the model may need to be retrained with better datasets, different hyperparameters, and/or a different set of categories.

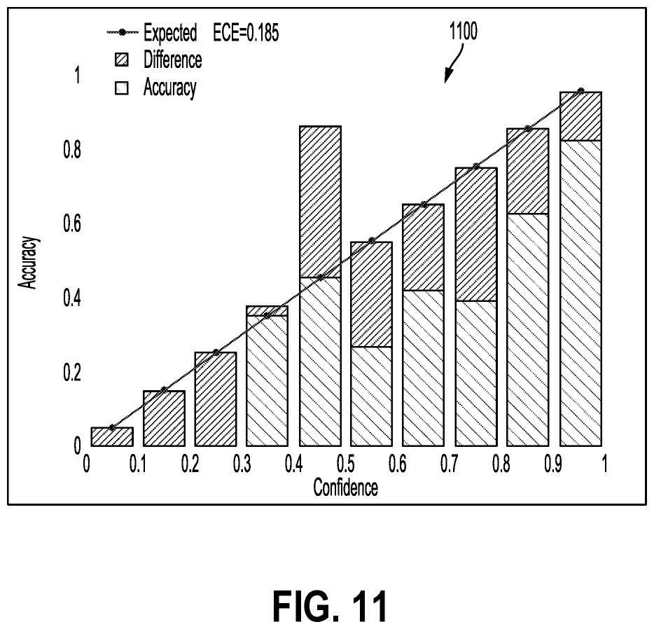

FIG. 11 depicts ECE chart 1100, which is a visual representation of ECE on a per bin basis. ECE chart 1100 provides a visual indication of which levels of model confidence have notably different levels of accuracy—in other words, how well the predicted confidence scores hold up against their associated actual accuracies.

### E. Word Clouds, Saliency, and Similarity

Turning back again to FIG. 8, word cloud section 814 depicts two word clouds, one for tokens that were most salient for correct predictions of categories, and the other for tokens that were most salient for incorrect predictions of categories. Each word cloud represents tokens at sizes that increase with their respective saliencies. For example, the most salient token for correct predictions was “account” (appearing in 42 correct predictions), and the most salient token for incorrect predictions was “bill” (appearing in 20 incorrect predictions). Thus, word cloud section 814 allows the user to easily identify the tokens that have the most impact on model correctness and incorrectness.

Saliency per bin of histogram section 812 can also displayed. If an upward bar (representing correct classifications) or a downward bar (representing incorrect classifications) for bin of histogram section 812 is actuated, a list of associated units of text may be displayed along with indications of the saliencies of tokens therein.

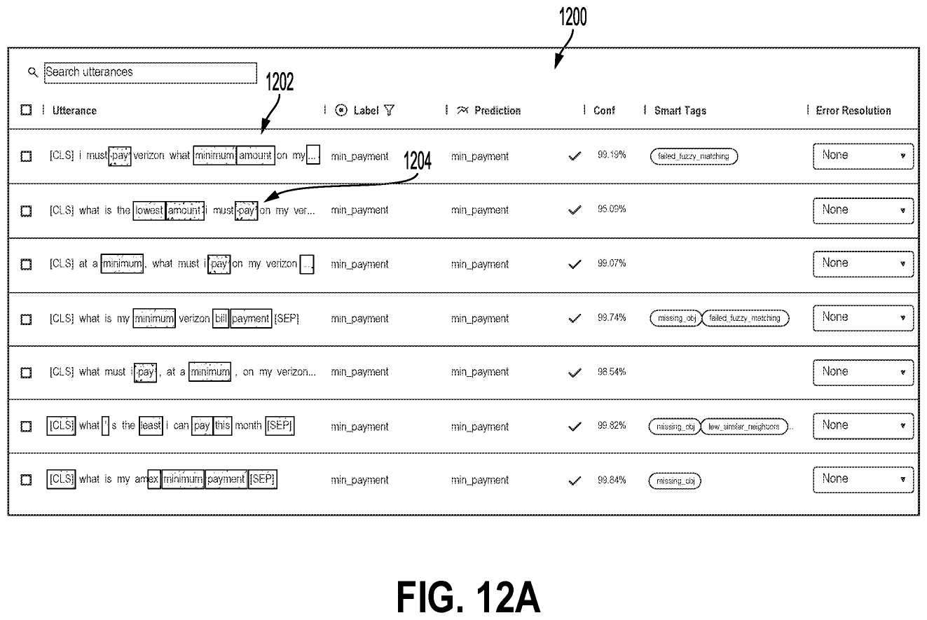

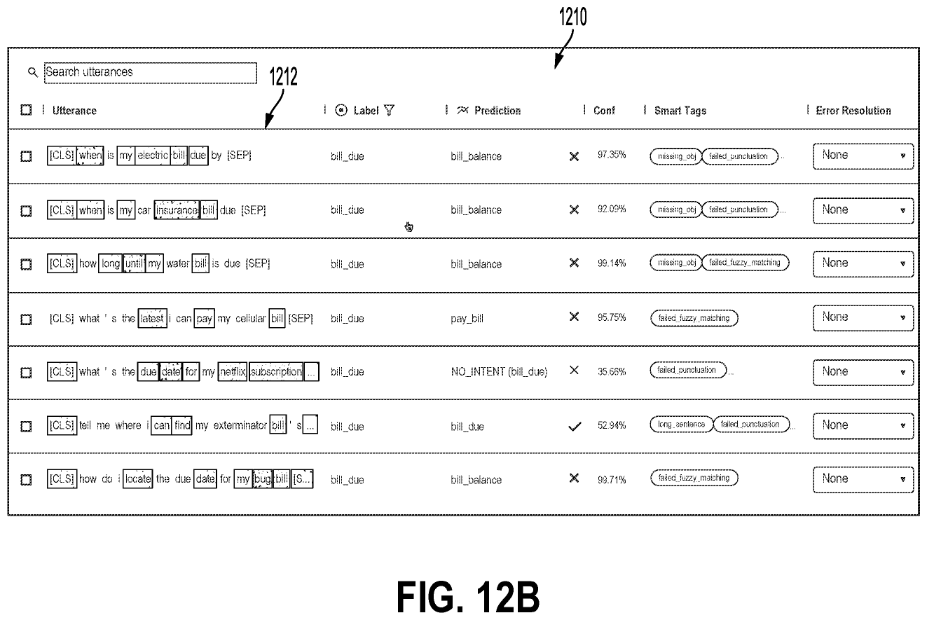

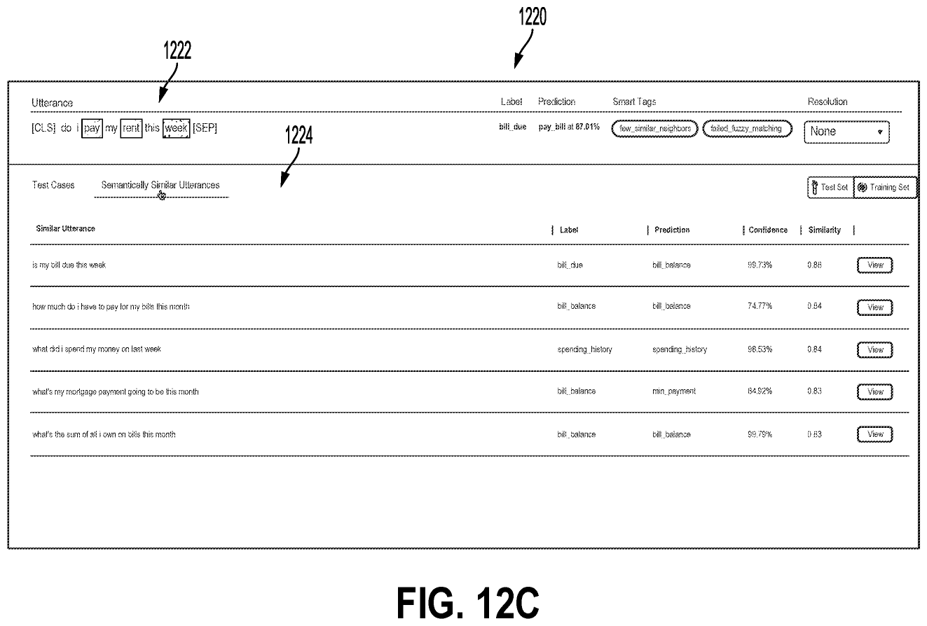

To that point, graphical user interface 1200 of FIG. 12A displays a list of units of text associated with the upward bar for the 90%-100% bin of histogram section 812. The saliency of each token in a unit of text (utterance) is shown with varying degrees of highlighting, along with that unit of text's actual category (label), predicted category (label), prediction confidence, smart tags, and error resolution options. This is a partial list, and more units of text may be available. In other embodiments, this interface may present some subset of and/or additional characteristics of, or metrics for, the unit of text.

As an example, entry 1202 in the list provides the unit of text, “I must pay Verizon what minimum amount on my . . . ” with the token “minimum” highlighted as most salient, the token “pay” highlighted as less salient than “minimum”, and the token “amount” highlighted as less salient than “pay”. All other tokens have negligible saliency. For this entry, both the actual category (label) and predicted category (label) are “min_payment”, indicating a correct classification by the model. The model indicated that it was 99.19% confident in this prediction. The smart tag “failed_fuzzy_matching” is associated with this entry, indicating that the entry was associated with failed test cases in the “fuzzy matching” group. This group includes adding neutral tokens, adding typographical errors, and contracting tokens or expanding contractions. This suggests that the model might not be robust with regard to this or similar entries, despite its correct prediction.

Further, an error resolution has not been selected. While doing so is optional, this dropdown menu allows the user to indicate what should be done about a classification error. For instance and as noted above, some classification errors can be marked as “acceptable” if there is overlap in categories or when a unit of text could reasonably be classified into more than one category, e.g., when it is determined that the classification is unclear even to human understanding.

As another example, in entry 1204, the unit of text does not include the token “minimum”. Nonetheless, the model correctly classified the unit of text into the “min_payment” category, with the token “lowest” being viewed as most salient. This suggests that the model has correctly inferred that the token “lowest” is a synonym to the token “minimum” (i.e., that “lowest” is relevant to the “min_payment” category in terms of its location in the embedding space).

Graphical user interface 1210 of FIG. 12B displays a list of units of text associated with the downward bar for the 90%-100% bin of histogram section 812. The saliency of each token in a unit of text (utterance) is shown with varying degrees of highlighting, along with that unit of text's actual category (label), predicted category (label), prediction confidence, smart tags, and error resolution options. This is a partial list, and more units of text may be available.

As an example, entry 1212 in the list provides the unit of text, “When is my electric bill due by” with the token “bill” highlighted as most salient, the token “when” highlighted as less salient than “bill”, and the token “electric” highlighted as less salient than “bill”. The tokens “my” and “due” have an even lower saliency. All other tokens (“is” and “by”) have negligible saliency. For this entry, the actual category (label) was “bill_due” and the predicted category (label) was “bill balance”, indicating an incorrect classification by the model. In other words, the individual who entered this unit of text wanted to know when their bill was due, but the model inferred that they wanted to know the balance of their bill.

The model indicated that it was 97.35% confident in this prediction, indicating that the model was highly confident in an incorrect prediction. The smart tags “missing_obj” and “failed punctuation” were associated with this entry (see above for descriptions). In this case, despite the tokens “bill” and “due” being in the unit of text, the model was unable to correctly predict that the intent of the text was to determine when a bill was due. This suggests that the model is poorly trained in this category and/or that the model itself has difficulties differentiating between the similar intents of determining bill balance, bill due dates, and making bill payments. If this issue were common, possible suggestions to address the issue could be to merge two or more of these categories, or to confirm that examples in these categories are labeled correctly in the training dataset.

To drill down further into an individual unit of text, such an entry can be actuated either from graphical user interface 1200, graphical user interface 1202, or from some other graphical user interface that displays a unit of text. For example, graphical user interface 1220 depicted in FIG. 12C may be displayed as a result of such an actuation.

Graphical user interface 1220 focuses on unit of text 1222, which is “Do I pay my rent this week?” Unit of text 1222 is not shown in graphical user interface 1200 or graphical user interface 1202, but could be in either list. Notably, unit of text 1222 has been predicted to be in the category “pay_bill” and is associated with the smart tag “few similar_neighbors”. As noted above, this smart tag indicates that unit of text 1222 has very few similar units of text from the same category, as determined by the embeddings in n-space.

For example, list 1224 contains units of text that are the most semantically similar to unit of text 1222, all of which were predicted to be in a different category. This also indicates that the model is poorly trained in one or more of these categories and/or that the model itself has difficulties differentiating between these categories. Again, a possible approach that could be suggested is to assess the categories to determine whether they could be merged or if they contain mislabeled examples in the training data.

In some embodiments, the discrepancies between ground truth categories and predicted categories can be displayed in a two-dimensional confusion matrix. Each axis of the confusion matrix may list the categories, and the content of each cell indicates the percent of units of text in the ground truth categories that were classified into the predicted categories.

### F. Filtering

Some or all of the above content displayed on graphical user interfaces can be filtered based on ground truth categories, predicted categories, resolutions, and/or smart tags. Turning back again to FIG. 8, filter section 810 provides lists of these options with associated checkboxes. Zero or more checkboxes can be selected at any point in time, thereby defining a filter. FIG. 8 depicts zero checkboxes being selected, and thus no filtering is applied to the displays of test results section 806, ECE section 808, histogram section 812, and word cloud section 814.

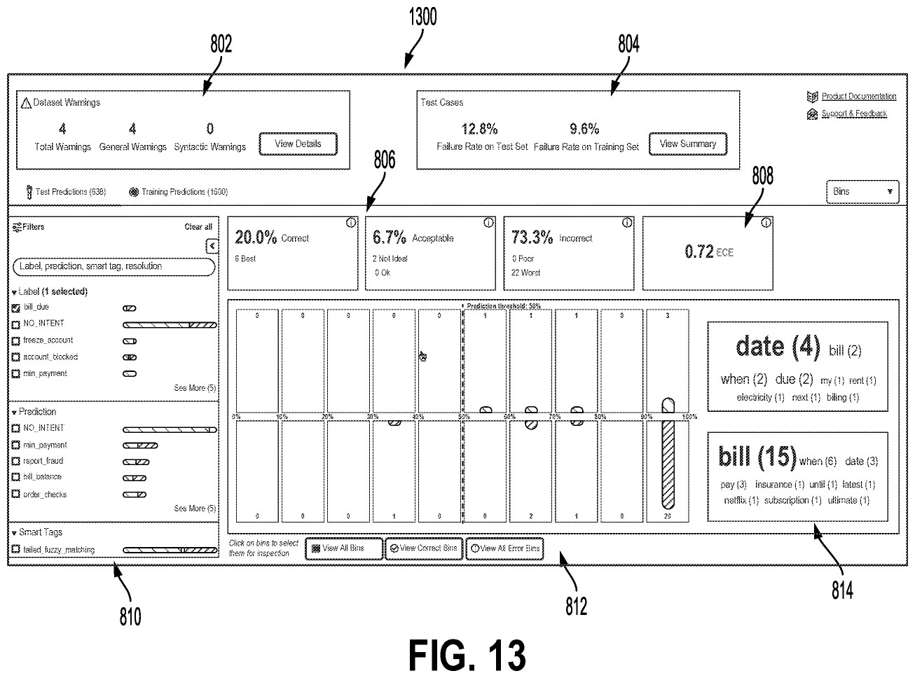

For example, FIG. 13 depicts graphical user interface 1300, which is identical to graphical user interface 800 except that the “bill_due” label is selected in filter section 810. This causes the displays of test results section 806, ECE section 808, histogram section 812, and word cloud section 814 to be updated so that they are only related to units of text with a ground truth category (label) of “bill_due”.

Such filtering can be useful to provide further insight into specific categories of interest, such as those for which the model has poor predictions. Doing so, in conjunction with the techniques above, can help the user identify the potential causes of model failure.

### IX. Example Operations

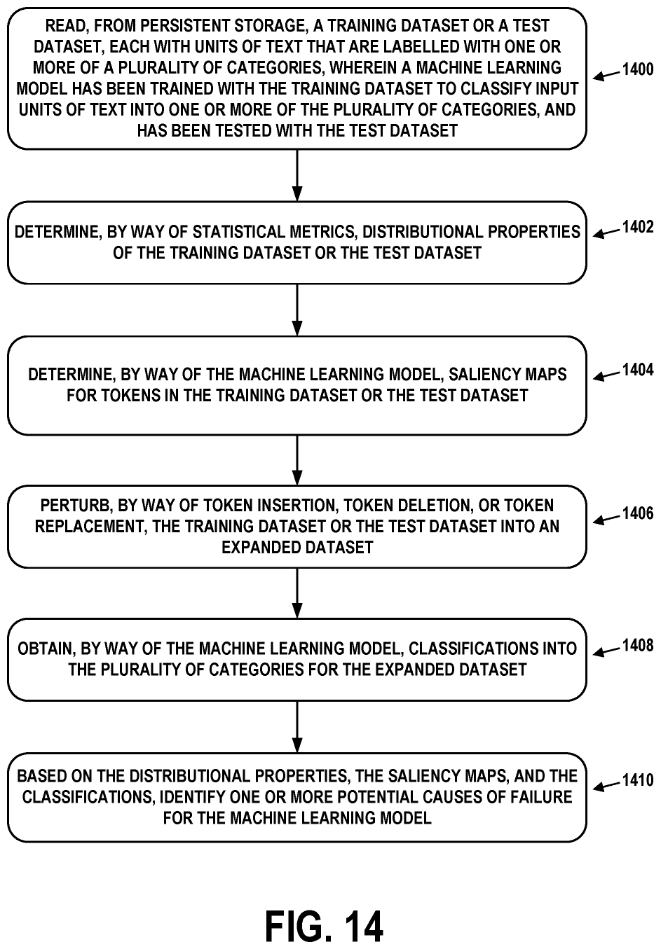

FIG. 14 is a flow chart illustrating an example embodiment. The process illustrated by FIG. 14 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 14 may be simplified by the removal of any one or more of the features shown therein. Further, these embodiments may be combined with features, aspects, and/or implementations of any of the previous figures or otherwise described herein.

Block 1400 may involve reading, from persistent storage, a training dataset or a test dataset, each with units of text that are labelled with one or more of a plurality of categories, wherein a machine learning model has been trained with the training dataset to classify input units of text into the plurality of categories, and has been tested with the test dataset.

Block 1402 may involve determining, by way of statistical metrics, distributional properties of the training dataset or the test dataset.

Block 1404 may involve determining, by way of the machine learning model, saliency maps for tokens in the training dataset or the test dataset.

Block 1406 may involve perturbing, by way of token insertion, token deletion, or token replacement, the training dataset or the test dataset into an expanded dataset.

Block 1408 may involve obtaining, by way of the machine learning model, classifications into the plurality of categories for the expanded dataset.

Block 1410 may involve, based on the distributional properties, the saliency maps, and the classifications, identifying one or more potential causes of failure for the machine learning mode.

In some embodiments, the distributional properties exhibit a divergence between the categories associated with the training dataset and the test dataset that exceeds a predetermined threshold, wherein the one or more potential causes of failure for the machine learning model include the divergence exceeding the predetermined threshold.

In some embodiments, the distributional properties exhibit, per the units of text, a difference in mean token count or a variability of token count between the training dataset and the test dataset that exceeds a predetermined threshold, wherein the one or more potential causes of failure for the machine learning model include the difference exceeding the predetermined threshold.

In some embodiments, the token insertion includes inserting stop words or punctuation into the units of text of the training dataset or the test dataset, wherein identifying the one or more potential causes of failure for the machine learning model comprises determining that a subset of the units of text of the training dataset or the test dataset were classified differently than their corresponding units of text in the expanded dataset. This may indicate a lack of model robustness.

In some embodiments, the token deletion includes deleting stop words or punctuation from the units of text of the training dataset or the test dataset, wherein identifying the one or more potential causes of failure for the machine learning model comprises determining that a subset of the units of text of the training dataset or the test dataset were classified differently than their corresponding units of text in the expanded dataset.

In some embodiments, the token replacement includes contracting tokens, expanding contracted tokens, or replacing tokens with synonyms in the units of text of the training dataset or the test dataset, wherein identifying the one or more potential causes of failure for the machine learning model comprises determining that a subset of the units of text of the training dataset or the test dataset were classified differently than their corresponding units of text in the expanded dataset.

In some embodiments, the saliency maps indicate that a stop word in one or more of the units of text has a saliency above a predetermined threshold, wherein the one or more potential causes of failure for the machine learning model include the saliency being above the predetermined threshold in the one or more of the units of text.

Some embodiments may involve: embedding the units of text into n-dimensional vectors based on semantic content thereof; based on the n-dimensional vectors, determining similarity metrics between pairs of the units of text; and based on the similarity metrics, identifying a particular unit of text of the units of text for which a predetermined number of most similar instances of the units of text have been labeled with different instances of the categories, wherein identifying the one or more potential causes of failure for the machine learning model comprises identifying that the particular unit of text was mislabeled or that there is an overlap between the categories or that other similar units of text are mislabeled.

In some embodiments, identifying the one or more potential causes of failure for the machine learning model comprises associating at least some of the units of text with smart tags that specify an abnormality found in the training dataset or the test dataset.

Some embodiments may involve: based on the one or more potential causes of failure for the machine learning model, modifying the training dataset so that: (i) the distributional properties between the training dataset and the test dataset are closer, (ii) the training dataset includes more tokens that are synonymous or similar to tokens with a saliency that is above a predetermined threshold, or (iii) the training dataset includes at least some of the units of text from the expanded dataset; and automatically retraining the machine learning model with the training dataset as modified.

Some embodiments may involve: obtaining representations of classification errors in the expanded dataset; obtaining, by way of the machine learning model, measures of classification confidence for each of the units of text; generating a graphical user interface, wherein the graphical user interface includes indications of the distributional properties, indications of the classification errors, and a histogram, wherein the histogram comprises a plurality of bins each representing respective ranges of the measures of classification confidence, and wherein each bin is associated with a first bar representing a first count of correct classifications and a second bar representing a second count of incorrect classifications; and providing, to a client device, a representation of the graphical user interface.

In some embodiments, the graphical user interface also includes two sets of aggregated word clouds, one for tokens in the units of text that were most salient for correct predictions of category labels, and another for tokens in the units of text that were most salient for incorrect predictions of category labels.

In some embodiments, the graphical user interface also includes a filter menu that allows filtering of the histogram based on the categories as labelled or the categories as predicted.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a training dataset and a test dataset, each with units of text that are labelled with one or more of a plurality of categories;
a machine learning model, trained with the training dataset to classify input units of text into the plurality of categories, and tested with the test dataset; and
one or more processors configured to:
read, from the persistent storage, the training dataset or the test dataset;
determine, by way of statistical metrics, distributional properties of the training dataset or the test dataset;
determine, by way of the machine learning model, saliency maps for tokens in the training dataset or the test dataset;
perturb, by way of token insertion, token deletion, or token replacement, the training dataset or the test dataset into an expanded dataset;
obtain, by way of the machine learning model, classifications into the plurality of categories for the expanded dataset; and
based on the distributional properties, the saliency maps, and the classifications, identify one or more potential causes of failure for the machine learning model.

2. The system of claim 1, wherein the distributional properties exhibit a divergence between the categories associated with the training dataset and the test dataset that exceeds a predetermined threshold, and wherein the one or more potential causes of failure for the machine learning model include the divergence exceeding the predetermined threshold.

3. The system of claim 1, wherein the distributional properties exhibit, per the units of text, a difference in mean token count or a variability of token count between the training dataset and the test dataset that exceeds a predetermined threshold, and wherein the one or more potential causes of failure for the machine learning model include the difference exceeding the predetermined threshold.

4. The system of claim 1, wherein the token insertion includes inserting stop words or punctuation into the units of text of the training dataset or the test dataset, and wherein identifying the one or more potential causes of failure for the machine learning model comprises determining that a subset of the units of text of the training dataset or the test dataset were classified differently than their corresponding units of text in the expanded dataset.

5. The system of claim 1, wherein the token deletion includes deleting stop words or punctuation from the units of text of the training dataset or the test dataset, and wherein identifying the one or more potential causes of failure for the machine learning model comprises determining that a subset of the units of text of the training dataset or the test dataset were classified differently than their corresponding units of text in the expanded dataset.

6. The system of claim 1, wherein the token replacement includes contracting tokens, expanding contracted tokens, or replacing tokens with synonyms in the units of text of the training dataset or the test dataset, and wherein identifying the one or more potential causes of failure for the machine learning model comprises determining that a subset of the units of text of the training dataset or the test dataset were classified differently than their corresponding units of text in the expanded dataset.

7. The system of claim 1, wherein the saliency maps indicate that a stop word in one or more of the units of text has a saliency above a predetermined threshold, and wherein the one or more potential causes of failure for the machine learning model include the saliency being above the predetermined threshold in the one or more of the units of text.

8. The system of claim 1, wherein the one or more processors are further configured to:
embed the units of text into n-dimensional vectors based on semantic content thereof;
based on the n-dimensional vectors, determine similarity metrics between pairs of the units of text; and
based on the similarity metrics, identify a particular unit of text of the units of text for which a predetermined number of most similar instances of the units of text have been labeled with different instances of the categories, wherein identifying the one or more potential causes of failure for the machine learning model comprises identifying that the particular unit of text was mislabeled or that there is an overlap between the categories or that other similar units of text are mislabeled.

9. The system of claim 1, wherein identifying the one or more potential causes of failure for the machine learning model comprises associating at least some of the units of text with smart tags that specify an abnormality found in the training dataset or the test dataset.

10. The system of claim 1, wherein the one or more processors are further configured to:
based on the one or more potential causes of failure for the machine learning model, modify the training dataset so that: (i) the distributional properties between the training dataset and the test dataset are closer, (ii) the training dataset includes more tokens that are synonymous or similar to tokens with a saliency that is above a predetermined threshold, or (iii) the training dataset includes at least some of the units of text from the expanded dataset; and
automatically retrain the machine learning model with the training dataset as modified.

11. The system of claim 1, wherein the one or more processors are further configured to:
obtain representations of classification errors in the expanded dataset;
obtain, by way of the machine learning model, measures of classification confidence for each of the units of text;
generate a graphical user interface, wherein the graphical user interface includes indications of the distributional properties, indications of the classification errors, and a histogram, wherein the histogram comprises a plurality of bins each representing respective ranges of the measures of classification confidence, and wherein each bin is associated with a first bar representing a first count of correct classifications and a second bar representing a second count of incorrect classifications; and
provide, to a client device, a representation of the graphical user interface.

12. The system of claim 11, wherein the graphical user interface also includes two sets of aggregated word clouds, one for tokens in the units of text that were most salient for correct predictions of category labels, and another for tokens in the units of text that were most salient for incorrect predictions of category labels.

13. The system of claim 11, wherein the graphical user interface also includes a filter menu that allows filtering of the histogram based on the categories as labelled or the categories as predicted.

14. A computer-implemented method comprising:
reading, from persistent storage, a training dataset or a test dataset, each with units of text that are labelled with one or more of a plurality of categories, wherein a machine learning model has been trained with the training dataset to classify input units of text into the plurality of categories, and has been tested with the test dataset;
determining, by way of statistical metrics, distributional properties of the training dataset or the test dataset;
determining, by way of the machine learning model, saliency maps for tokens in the training dataset or the test dataset;
perturbing, by way of token insertion, token deletion, or token replacement, the training dataset or the test dataset into an expanded dataset;
obtaining, by way of the machine learning model, classifications into the plurality of categories for the expanded dataset; and
based on the distributional properties, the saliency maps, and the classifications, identifying one or more potential causes of failure for the machine learning model.

15. The computer-implemented method of claim 14, further comprising:
embedding the units of text into n-dimensional vectors based on semantic content thereof;
based on the n-dimensional vectors, determining similarity metrics between pairs of the units of text; and
based on the similarity metrics, identifying a particular unit of text of the units of text for which a predetermined number of most similar instances of the units of text have been labeled with different instances of the categories, wherein identifying the one or more potential causes of failure for the machine learning model comprises identifying that the particular unit of text was mislabeled or that there is an overlap between the categories or that other similar units of text are mislabeled.

16. The computer-implemented method of claim 14, wherein identifying the one or more potential causes of failure for the machine learning model comprises associating at least some of the units of text with smart tags that specify an abnormality found in the training dataset or the test dataset.

17. The computer-implemented method of claim 14, further comprising:
based on the one or more potential causes of failure for the machine learning model, modifying the training dataset so that: (i) the distributional properties between the training dataset and the test dataset are closer, (ii) the training dataset includes more tokens that are synonymous or similar to tokens with a saliency that is above a predetermined threshold, or (iii) the training dataset includes at least some of the units of text from the expanded dataset; and
automatically retraining the machine learning model with the training dataset as modified.

18. The computer-implemented method of claim 14, further comprising:
obtaining representations of classification errors in the expanded dataset;
obtaining, by way of the machine learning model, measures of classification confidence for each of the units of text;
generating a graphical user interface, wherein the graphical user interface includes indications of the distributional properties, indications of the classification errors, and a histogram, wherein the histogram comprises a plurality of bins each representing respective ranges of the measures of classification confidence, and wherein each bin is associated with a first bar representing a first count of correct classifications and a second bar representing a second count of incorrect classifications; and
providing, to a client device, a representation of the graphical user interface.

19. The computer-implemented method of claim 18, wherein the graphical user interface also includes two sets of aggregated word clouds, one for tokens in the units of text that were most salient for correct predictions of category labels, and another for tokens in the units of text that were most salient for incorrect predictions of category labels.

20. An article of manufacture including a non-transitory computer-readable medium, having stored thereon program instructions that, upon execution by a computing system, cause the computing system to perform operations comprising:
reading, from persistent storage, a training dataset or a test dataset, each with units of text that are labelled with one or more of a plurality of categories, wherein a machine learning model has been trained with the training dataset to classify input units of text into the plurality of categories, and has been tested with the test dataset;
determining, by way of statistical metrics, distributional properties of the training dataset or the test dataset;
determining, by way of the machine learning model, saliency maps for tokens in the training dataset or the test dataset;
perturbing, by way of token insertion, token deletion, or token replacement, the training dataset or the test dataset into an expanded dataset;
obtaining, by way of the machine learning model, classifications into the plurality of categories for the expanded dataset; and
based on the distributional properties, the saliency maps, and the classifications, identifying one or more potential causes of failure for the machine learning model.
